(19) United States
(12) Patent Application Publication
(10) Pub. No.: US 2020/0343828 A1
(43) Pub. Date: Oct. 29, 2020

(54) INVERTER USING POWER MODULE

(71) Applicants: HYUNDAI MOTOR COMPANY, Seoul (KR); KIA MOTORS CORPORATION, Seoul (KR)

(72) Inventors: Hyun Koo Lee, Goyang-si (KR); Sung Won Park, Incheon (KR); Hyeon Uk Kim, Hwaseong-si (KR)

(21) Appl. No.: 16/580,584

(22) Filed: Sep. 24, 2019

(30) Foreign Application Priority Data
Apr. 26, 2019 (KR) 10-2019-0049329

(51) Int. Cl. H02M 7/537; H02M 1/32

(52) U.S. Cl. CPC H02M 7/537; H02M 2001/327; H02M 1/32

(57) ABSTRACT

An inverter includes: an upper module having three switching elements, among switching elements defining three poles of a three-phase inverter, which are connected to a positive electrode on a first substrate; and a lower module having three switching elements, among the switching elements defining the three poles of the three-phase inverter, connected to a negative electrode on a second substrate. The upper module and the lower module are configured to be stacked on each other, and a positive terminal of the upper module and a negative terminal of the lower module are stacked so as to be opposite each other with an insulator placed therebetween.

### CROSS REFERENCE TO RELATED APPLICATION

The present application claims priority to Korean Patent Application No. 10-2019-0049329, filed on Apr. 26, 2019 in the Korean Intellectual Property Office, the entire contents of which is incorporated herein by reference.

### TECHNICAL FIELD

The present disclosure relates to a power module configured to include switching elements and an inverter configured to drive a motor using the same.

### BACKGROUND

In a hybrid vehicle or an electric vehicle, an inverter is used to drive a motor. A plurality of switching elements which are power semiconductors are used in the inverter, in order to precisely control a three-phase alternating current to be supplied to the motor.

The inverter for controlling a three-phase current usually requires six switching elements, in which two switching elements performing complementary switching are connected in series to form a single pole or a leg, and three such poles are connected in parallel to the power source, thereby constituting the inverter.

In the related art, a power module has one switching element constituted on one substrate together with other necessary components such as a diode, so that one inverter is configured by combining six such power modules. Alternatively, a power module has two switching elements constituting one pole constituted on one substrate, so that one inverter is configured by combining three power modules.

As described above, when the inverter is configured using the six power modules, or when the inverter is configured using three power modules, there is a tendency that the number components and space required for circuit connection between the power modules are relatively large.

It is to be understood that the foregoing description of an inventive concept is merely for the purpose of promoting an understanding of the background of the present disclosure and should not be admitted as prior art that has already been known to those skilled in the art.

### SUMMARY

The present disclosure has been made keeping in mind the above problems occurring in the related art, and the present disclosure has an object to provide an inverter using power modules, in which the inverter including a plurality of power modules is compactly configured compared to the related art, the number of components and space required for electrical connection between the power modules are greatly reduced and thus the cost of the inverter is reduced, and the density of the current output from the inverter is greatly increased in comparison with the volume occupied by the inverter, thereby improving the output density.

In order to achieve the above object, an inverter using a power module according to an aspect of the present disclosure may comprise: an upper module in which three first switching elements, among switching elements defining three poles of a three-phase inverter, are connected to a positive electrode and disposed on a first substrate; and a lower module in which three second switching elements, among the switching elements defining the three poles of the three-phase inverter, are connected to a negative electrode and disposed on a second substrate, wherein the upper module and the lower module are configured to be stacked on each other, and a positive terminal of the upper module and a negative terminal of the lower module are stacked so as to be opposite each other with an insulator placed therebetween.

The positive terminal and output terminals of the switching elements constituting the upper module may be spaced apart from each other on a same plane in a same direction; and the negative terminal and output terminals of the switching elements constituting the lower module may be spaced apart from each other on a same plane in a same direction.

The output terminals of the switching elements constituting the upper module and the output terminals of the switching elements constituting the lower module may be stacked so as to be opposite each other one-by-one, so as to form a pole.

The positive terminal of the upper module may be arranged on one side of a series of output terminals spaced apart from each other, and the negative terminal of the lower module may be arranged on the other side of a series of output terminals spaced apart from each other.

An intermediate cooling medium may be interposed between the upper module and the lower module, an upper cooling medium may be provided on a top side of the upper module, a lower cooling medium may be provided on a bottom side of the lower module, and the upper cooling medium, the intermediate cooling medium, and the lower cooling medium may be cooperated with each other to perform a cooling function.

The upper cooling medium, the intermediate cooling medium, and the lower cooling medium may be configured with an upper cooling tube, an intermediate cooling tube, and a lower cooling tube, respectively, and the upper module and the lower module may be cooled by circulating a refrigerant through a refrigerant inlet pipe and a refrigerant outlet pipe which are connected to supply and recover the refrigerant to/from the upper cooling tube, the intermediate cooling tube, and the lower cooling tube.

The upper module may include: a first insulating substrate which is in surface contact with a top side of the intermediate cooling tube; and a second insulating substrate which is in surface contact with a bottom side of the upper cooling tube, wherein the switching elements are mounted on the first insulating substrate or the second insulating substrate; and conductor blocks are interposed between the switching elements and the substrate, on which the switching elements are not mounted, among the first insulating substrate and the second insulating substrate.

The lower module may include: a third insulating substrate which is in surface contact with a top side of the lower cooling tube; and a fourth insulating substrate which is in surface contact with a bottom side of the intermediate cooling tube, wherein the switching elements are mounted on the third insulating substrate or the fourth insulating substrate; and conductor blocks are interposed between the switching elements and the substrate, on which the switching elements are not mounted, among the third insulating substrate and the fourth insulating substrate.

In addition, in order to achieve the above object, a power module according to another aspect of the present disclosure may comprise: three switching elements, among switching elements defining three poles of a three-phase inverter, connected to a positive electrode and arranged on a substrate; and a positive terminal connected to respective switching elements among the three switching elements, wherein the positive terminal and output terminals of the three switching elements are spaced apart from each other on a same plane in a same direction.

In addition, in order to achieve the above object, a power module according to another aspect of the present disclosure may comprise: three switching elements, among switching elements defining three poles of a three-phase inverter, connected to a negative electrode and arranged on a substrate; and a negative terminal connected to respective switching elements among the three switching elements, wherein the negative terminal and output terminals of the switching elements are spaced apart from each other on a same plane in a same direction.

According to the present disclosure, the inverter including a plurality of power modules can be compactly configured compared to the related art, the number of components and space required for electrical connection between the power modules can be greatly reduced and thus the cost of the inverter can be reduced, and the density of the current output from the inverter can be greatly increased in comparison with the volume occupied by the inverter, thereby improving the output density.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view illustrating a power module of an inverter according to the present disclosure;

FIG. 2 is a perspective view of an inverter according to the present disclosure;

FIG. 3 is a cross-sectional view taken along a line III-III in FIG. 2; and

FIG. 4 is a cross-sectional view taken along a line IV-IV in FIG. 2.

### DETAILED DESCRIPTION

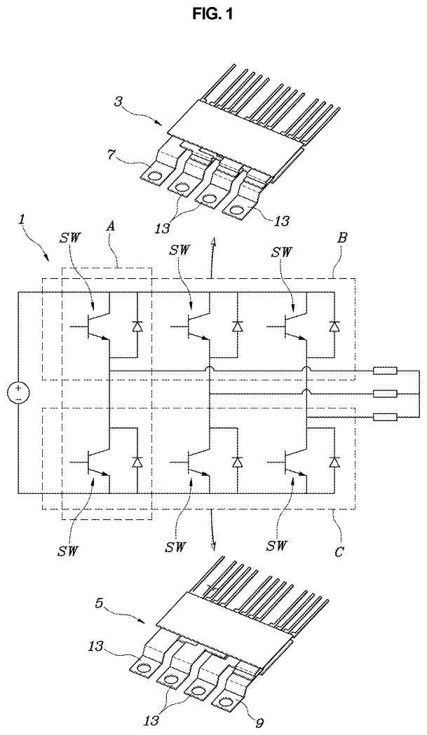

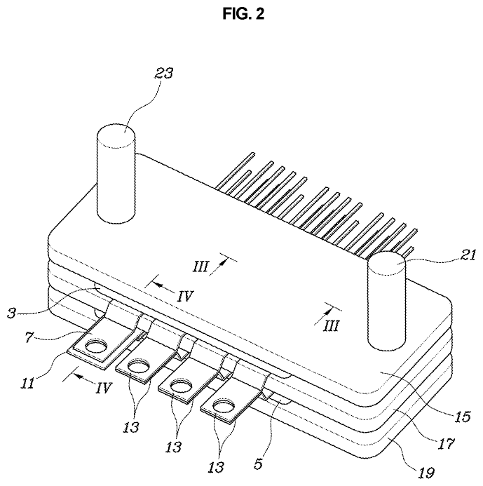

Referring to FIGS. 1 to 4, an inverter 1 according an embodiment of the present disclosure includes: an upper module 3 in which three switching elements SW connected to a positive electrode are assembled on one substrate among switching elements SW forming three poles of a three-phase inverter; and a lower module 5 in which three switching elements SW connected to a negative electrode are assembled on one substrate among switching elements SW forming three poles of a three-phase inverter, wherein the upper module 3 and the lower module 5 are configured in an overlapping manner with each other, and a positive terminal 7 of the upper module 3 and a negative terminal 9 of the lower module 5 are stacked opposite each other with an insulator 11 placed therebetween.

That is, referring to FIG. 1, a portion indicated by A is to illustrate a structure in which a power module is constituted on a per-pole basis in the related art, and herein the power module is configured in which two switching elements SW configuring one pole are arranged on one substrate. The inverter according to the present disclosure is configured as indicated by B and C, in which an upper module 3 (indicated by B) is configured in which three switching elements SW connected to a positive electrode constituting one inverter are assembled on one substrate, and a lower module 5 (indicated by C) is configured in which three switching elements SW connected to a negative electrode are assembled on one substrate, and herein the upper module 3 and the lower module 5 are combined one-by-one, thereby constituting one inverter.

That is, according to the present disclosure, the power module is collectively referred to as the upper module 3 and the lower module 5. Here, the upper module 3 is provided so that three switching elements SW connected to the positive electrode are arranged on one substrate among switching elements forming three poles of a three-phase inverter, and a positive terminal 7 connected to the respective switching elements SW and output terminals 13 of the switching elements SW are spaced apart from each other while forming the same plane in the same direction.

In addition, the lower module 5 is provided so that three switching elements SW connected to the negative electrode are arranged on one substrate among switching elements forming three poles of a three-phase inverter, and a negative terminal 9 connected to the respective switching elements SW and output terminals 13 of the switching elements SW are spaced apart from each other while forming the same plane in the same direction.

In this embodiment, as illustrated in FIG. 1, the positive terminal 7 of the upper module 3 is arranged on the left side of a series of output terminals 13 spaced apart from each other, and the negative terminal 9 of the lower module 5 is arranged on the right side of the series of output terminals 13 spaced apart from each other, so that when the lower module 5 is stacked on the upper module 3 with turning the lower module 5 inside out on the basis of the upper module 3, the positive terminal 7 and the negative terminal 9 are stacked opposite each other, and the output terminals 13 of the switching element SW constituting the upper module 3 and the output terminals 13 of the switching element SW constituting the lower module 3 are stacked opposite each other so as to form a pole.

Herein, since the insulator 11, such as thin insulating paper or the like, is interposed between the positive terminal 7 and the negative terminal 9 as described above, the parasitic inductance may be minimized.

As described above, according to the present disclosure, since the electrical connection state of the inverter 1 may be established only by arranging and stacking the upper module 3 and the lower module 5 with each other, the number of components and space required for electrical and structural connection of the modules in the related art are not required, whereby it is possible to construct the inverter that is compact and has high power density and reduce the manufacturing cost of the inverter.

Portions where the output terminals 13 of the upper module 3 and the output terminals 13 of the lower module 5 are in contact with each other may be connected to each other via bolts or soldering.

Since the inverter 1 generates a much heat by the high-speed switching operation of the switching elements SW constituting the power modules, an appropriate cooling function is required. Accordingly, the inverter according to the present disclosure is configured so that an intermediate cooling medium is interposed between the lower module 3 and the lower module 5, an upper cooling medium is provided on a top side of the upper module 3, a lower cooling medium is provided on a bottom side of the lower module 5, and the upper cooling medium, the intermediate cooling medium, and the lower cooling medium are cooperated with each other to perform a cooling function.

Here, the intermediate cooling medium, the upper cooling medium, and the lower cooling medium may be configured with a cooling tube in which a refrigerant circulates as described later, or may be configured with various parts that may smoothly transfer heat via conduction by achieving a surface contact state, such as an active cooling plate utilizing a thermoelectric element or the like.

In the present embodiment, the upper cooling medium, the intermediate cooling medium, and the lower cooling medium are configured with an upper cooling tube 15, an intermediate cooling tube 17, and a lower cooling tube 19, respectively, and the upper module 3 and the lower module 5 may be cooled by circulating the refrigerant through a refrigerant inlet pipe 21 and a refrigerant outlet pipe 23 which are connected so as to supply and recover the refrigerant to/from the upper cooling tube 15, the intermediate cooling tube 17, and the lower cooling tube 19.

The refrigerant inlet pipe 21 and the refrigerant outlet pipe 23 are connected to a refrigerant circulation device including a refrigerant pump for supplying and recovering the refrigerant.

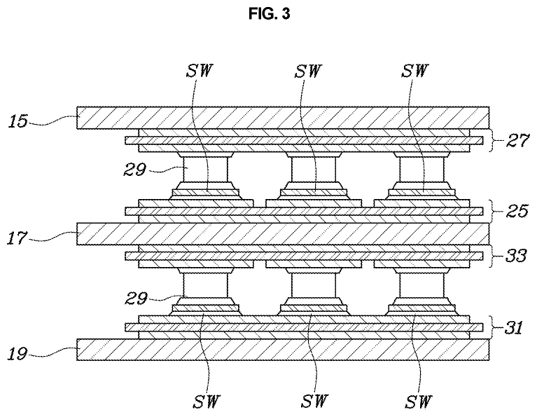

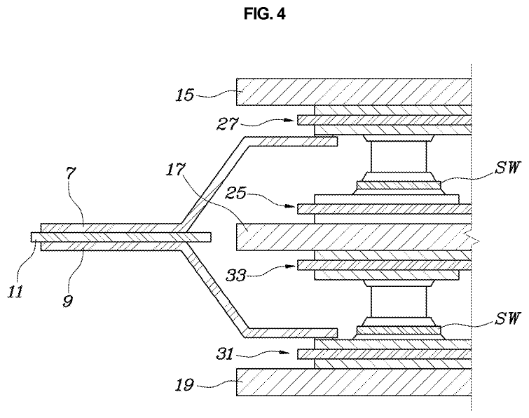

The upper module 3 and the lower module 5 according to the present disclosure have a cross-sectional structure as shown in FIGS. 3 and 4, so that the cooling function of the upper cooling tube 15, the intermediate cooling tube 17, and the lower cooling tube 19 works better on the switching elements SW.

That is, the upper module 3 includes a first insulating substrate 25 which is in surface contact with a top side of the intermediate cooling tube 17 and a second insulating substrate 27 which is in surface contact with a bottom side of the upper cooling tube 15. The switching elements SW are mounted on the first insulating substrate 25 or the second insulating substrate 27, and conductor blocks 29 are interposed between the switching elements SW and the substrate, on which the switching elements SW are not mounted, among the first insulating substrate 25 and the second insulating substrate 27.

In addition, the lower module 5 includes a third insulating substrate 31 which is in surface contact with a top side of the lower cooling tube 19 and a fourth insulating substrate 33 which is in surface contact with a bottom side of the intermediate cooling tube 17. The switching elements SW are mounted on the third insulating substrate 31 or the fourth insulating substrate 33, and conductor blocks 29 are interposed between the switching elements SW and the substrate, on which the switching elements SW are not mounted, among the third insulating substrate 31 and the fourth insulating substrate 33.

Here, the conductor block 29 is made of a metal block or the like, which is excellent in heat transfer via conduction, so that the heat generated from the switching elements SW may be smoothly discharged through the upper and lower sides of the switching element SW.

Herein, the insulating substrate means a substrate in which two metal conductive layers are boned with an insulating layer placed therebetween, and an electric pattern is formed on one metal conductive layer. Such insulating substrate enables high current operation while minimizing the influence of parasitic inductance, thereby achieving a high switching speed. For example, a direct bond copper (DBC) substrate may be used as the insulating substrate.

The present disclosure may be provided to be bonded via soldering between the switching element and the insulating substrate, between the switching element and the conductive block, and between the conductive block and the insulating substrate.

Although an exemplary embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. An inverter using a power module, the inverter comprising:
an upper module having three first switching elements, among switching elements defining three poles of a three-phase inverter, which are connected to a positive electrode and disposed on a first substrate; and
a lower module having three second switching elements, among the switching elements defining the three poles of the three-phase inverter, which are connected to a negative electrode and disposed on a second substrate.

2. The connection system of claim 1, wherein the upper module and the lower module are configured to be stacked on each other, and
wherein a positive terminal of the upper module and a negative terminal of the lower module are stacked so as to be opposite each other with an insulator placed therebetween.

3. The connection system of claim 2, wherein the positive terminal and output terminals of the first switching elements are spaced apart from each other on a same plane in a same direction, and
wherein the negative terminal and output terminals of the second switching elements are spaced apart from each other on a same plane in a same direction.

4. The connection system of claim 3, wherein the output terminals of the first switching elements and the output terminals of the second switching elements are stacked so as to be opposite each other one-by-one in a pole.

5. The connection system of claim 3, wherein the positive terminal of the upper module is arranged in series with, and spaced apart from, the output terminals of the first switching elements, and
wherein the negative terminal of the lower module is arranged in series, and spaced apart from, the output terminals of the second switching elements.

6. The connection system of claim 1, further comprising:
an intermediate cooling medium interposed between the upper module and the lower module;
an upper cooling medium disposed on a top side of the upper module; and
a lower cooling medium disposed on a bottom side of the lower module,
wherein the upper cooling medium, the intermediate cooling medium, and the lower cooling medium are collectively configured to perform a cooling function.

7. The connection system of claim 6, wherein the upper cooling medium, the intermediate cooling medium, and the lower cooling medium comprise an upper cooling tube, an intermediate cooling tube, and a lower cooling tube, respectively, and
wherein the upper module and the lower module are arranged to be cooled by circulating a refrigerant through a refrigerant inlet pipe and a refrigerant outlet pipe which are connected to supply and recover the refrigerant to and from the upper cooling tube, the intermediate cooling tube, and the lower cooling tube.

8. The connection system of claim 7, wherein the upper module includes:
a first insulating substrate which is in surface contact with a top side of the intermediate cooling tube; and
a second insulating substrate which is in surface contact with a bottom side of the upper cooling tube,
wherein the first switching elements are mounted on the first insulating substrate or the second insulating substrate, and
wherein conductor blocks are interposed between the first switching elements and one of the first insulating substrate and the second insulating substrate, on which the first switching elements are not mounted.

9. The connection system of claim 7, wherein the lower module includes:
a third insulating substrate which is in surface contact with a top side of the lower cooling tube; and
a fourth insulating substrate which is in surface contact with a bottom side of the intermediate cooling tube,
wherein the second switching elements are mounted on the third insulating substrate or the fourth insulating substrate, and
wherein conductor blocks are interposed between the second switching elements and one of the third insulating substrate or the fourth insulating substrate, on which the second switching elements are not mounted.

10. A power module comprising:
three switching elements, among switching elements defining three poles of a three-phase inverter, connected to a positive electrode and arranged on a substrate; and
a positive terminal connected to respective switching elements among the three switching elements,
wherein the positive terminal and output terminals of the switching elements are spaced apart from each other on a same plane in a same direction.

11. A power module comprising:
three switching elements, among switching elements defining three poles of a three-phase inverter, connected to a negative electrode and arranged on a substrate; and
a negative terminal connected to respective switching elements among the three switching elements,
wherein the negative terminal and output terminals of the switching elements are spaced apart from each other on a same plane in a same direction.
